(19) United States
(12) Patent Application Publication
(10) Pub. No.: US 2026/0318432 A1
(43) Pub. Date: Oct. 15, 2026

(54) IMPROVEMENTS IN OR RELATED TO PRESSURE RELIEF VALVES

(71) Applicants: lan Craig Paterson, Auckland (NZ); Globalforce IP Limited, Auckland (NZ)

(72) Inventor: Ian Craig PATERSON, Auckland (NZ)

(21) Appl. No.: 19/119,228

(22) PCT Filed: Oct. 12, 2023
(86) PCT No.: PCT/IB2023/060257

§ 371 Date: Apr. 8, 2025

(30) Foreign Application Priority Data
Oct. 12, 2022 (NZ) 793273
Oct. 12, 2022 (NZ) 793330

(51) Int. Cl. F16K 17/04; F16K 1/44; F16K 31/363

(52) U.S. Cl. CPC F16K 17/04; F16K 1/44; F16K 31/363

(57) ABSTRACT

Disclosed is a pressure relief valve with inlet and outlet ports, to hold pressure from outlet until a set pressure is achieved at the inlet. The valve has a valve member located between the inlet and outlet ports, movable between an open position to allow a fluid flow between the ports, and closed position to prevent fluid flow. Inlet pressure acts on the valve member to increase its closing force. Provided is a movable sensing spindle in fluid communication with the inlet pressure and a reference pressure, the sensing spindle having a first position, and a second position. Increased pressure difference between the inlet pressure and reference toward the set pressure moves the sensing spindle to eventually acts on the valve member to move it away from it's sealing position and thus provide an opening for fluid to flow from the inlet to the outlet.

### TECHNICAL FIELD OF THE INVENTION

The present invention relates to valves.

In particular, though not solely, the present invention is directed to pressure release valves.

### BACKGROUND OF THE INVENTION

A pressure relieve valve (PRV) is used to vent pressure from a process when that inlet pressure exceeds a desired limit. This may be for example, but not limited to safety, or to keep a process within certain operational bounds.

Typical pressure relief valves use a energised valve member to hold pressure at an inlet. When the pressure at the inlet exceeds the force holding the valve member shut the valve member opens to port, release, relieve or otherwise allow the excess pressure to escape, typically through an outlet. Energising the valve member may be achieved by conventionally by a spring acting down onto the valve member, or by other means, e.g. pilot operated, mass loading, or gas loading (on the backside of a piston acting on the valve member).

All of these existing systems have disadvantages. A conventional relief valve has high seating force of the valve which reduces as pressure rises until the pressure force overwhelms the seating spring force. This means when the valve is sitting in a warehouse or installed by otherwise unpressurised the valve is constantly highly stressed. This requires the seat/seal system must be designed to sustain the full spring preload force. This is either achieved by a large seating face on metal/metal seals—which result in poor sealing performance as set pressure approached—leading to low pressure simmer/warn/leakage. Alternatively, a soft seal can sometimes be utilised in less onerous use cases in conjunction with a hard stop to sustain the high force of the spring and prevent over compression of the soft seal. However soft seal inserts are not generally recommended in some situations, for high temperature steam use for example. In the case of a hard-stopped soft seated conventional pressure relief valve there is a maximum compression achievable on the soft seal (due to the hard stop). Polymeric sealing materials can (especially when exposed to higher temperatures) compression set—change shape—thereby reducing the seating force being transmitted through the polymer part. This can over time result in a lowered or variable true opening pressure or set pressure—this is undesirable as set pressures must be controlled to within tight parameters. Pressure relief valves which fail their set pressure tests must be re-set or removed from service for servicing or replacement.

Conventional PRVs also have further disadvantages as the cost is high at large sizes, large nozzle diameters and pressures lead to large forces, springs and other hardware. They have low seat tightness and simmer pressure (pressure at which the valve starts to leak/barely open generally about 90% of set pressure). They also have poor performance in applications with variable or high backpressure due to lack of pressure balancing. This negatively effects their performance, and they can lose accuracy due to outlet pressure directly affecting the pressure at which the valve operates. To operate in a variable backpressure environment a bellows or other balancing method is required—these can be mechanically sensitive and have a relatively low backpressure tolerance compared to a pilot operated release valve; adding balancing bellows is expensive. Alternatively, piston seals between the process fluid volume and atmosphere (the environment) can be used to balance the spindle to remove this effect. A disadvantage of piston seals in comparison to bellows is that the guide seal and spindle seals are normally elastomers or plastic so temperature and chemical compatibility with the service fluid needs to be considered, and still require the same high spring forces for high pressure applications, and result in high seating loads.

Further, in direct acting PRVs which use soft (otherwise called ‘resilient’) seating elements without hard stops, the constant force acting on the soft seating elements can reduce the life of the valve due to compression setting of the soft material—resulting in either premature leakage or a variable opening or set pressure.

Conventional valves also need large, high force springs for many use cases. For high flow capacity or high pressure use cases large springs must be used—this is because in conventional pressure relief valves the pressure sensing area is equal to the nozzle diameter—and therefore dictates the maximum possible flow.

The reducing seating force as pressure increases, results in low simmer (otherwise called warn or leak) below set pressure, which is detrimental to the efficiency of many process systems.

Conventional PRVs can be affected by high or variable discharge pressure as this can change the set point of the valve significantly either making conventional valves unusable for certain use cases—or requiring a conventional valve with additional balancing features, with additional cost and complexity.

While a balanced piston PRV valve may be suitable in some use cases—the piston seal must be of the same diameter as the seat and must be of high integrity as it seals the process fluid from the environment. Highly leak resistant/emissions regulation compliant valve stem packings such as high temperature graphite or braided Teflon, especially those of high diameter, tend to result in high friction—too high to provide an accurate enough set point for critical safety systems.

A Balanced Bellows PRV provides an essentially frictionless seal and can isolate the valve from the effects of backpressure on the valve. However, for a bellows PRV to provide the desired balancing effect the bellows must be large enough in diameter for the nozzle pressure area and the bellows to match. For a relatively short, large diameter, and pressure resistant bellows to be able to displace a significant distance it must be made of multiple very thin and fragile layers. The design trade-offs exhibited in these bellows typically limits the backpressure they can handle—Commonly backpressure must be limited to 20% or 30% of the valves set pressure.

A pilot operated pressure relief valve (PORV or POPRV) has limited high temperature applications due to sliding soft seals. They also cannot be used in hygienic Clean in Place (CIP) applications due to the complex and small diameter tubing and pilot valve. Due to the small flow paths in the pilot valve and tubing, PORVs may not be a good fit for process medias that are highly viscous or contain high levels of particulate. In smaller sizes, PORVs are typically higher cost than conventional valves, they also often use non-standard porting (e.g. API 526). A PORV is often perceived as complex and specialised in comparison to conventional valves. Their multi-stage operation can in some instances result in slower reaction than direct acting valves. They require separate pilot control valve, and small bore tubing and sensing valves—driving cost and assembly complexity.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved pressure relief valve or to overcome the above shortcomings or address the above desiderata, or to at least provide the public with a useful choice.

### BRIEF DESCRIPTION OF THE INVENTION

In a first aspect the present invention consists in a pressure relief valve to operate on an inlet fluid under pressure to prevent, and allow, the inlet fluid to flow from an inlet to an outlet, comprising or including,

A valve body having the inlet leading to an interior of the valve body, and the outlet exiting from the interior,

A valve member operatively located within the valve body, having a first pressure surface on a first side thereof in fluid communication with the inlet fluid, and a second pressure surface on a second side thereof, opposing the first surface, also in fluid communication with the inlet fluid, a first sealing surface on the first side to seal off the inlet from the outlet,
a first biasing force urging the valve member to a first valve position whereby it is sealing the inlet from the outlet,

A sensing spindle in fluid communication with the inlet, having a third pressure surface in fluid communication with the inlet fluid, a second biasing force to urge the sensing spindle to a first spindle position against the inlet fluid pressure acting on the third pressure surface, the second biasing force not additive to the first biasing force,

Such that in use, the inlet fluid acting on the second pressure surface is additive to the first biasing force in sealing the first sealing surface to the inlet, and

When the inlet pressure exceeds a set pressure, the sensing spindle is moved to, or toward, a second spindle position that breaks the seal between the first sealing surface and the inlet, and the inlet fluid can exit to the outlet.

Preferably when at pressure, but below set pressure the inlet fluid acting on the second pressure surface creates a force that greater then the first biasing force in sealing the first sealing surface to the inlet.

In a first aspect the present invention consists in a pressure relief valve to operate on an inlet fluid under pressure to prevent, and allow, the inlet fluid to flow from an inlet to an outlet, comprising or including,

A valve body having the inlet leading to an interior of the valve body, and the outlet exiting from the interior,

A valve bonnet removably engaged to the valve body between the first port and the second port, to further define a duct therebetween,

A valve member having an endless skirt within the duct, the endless skirt having an outer periphery, which the valve body at least in part defines an annular chamber about, and the endless skirt having an inner periphery which defines an inner chamber, the valve member having a closed position to prevent flow of fluid, and an open position to allow flow of fluid,
the endless skirt in sliding and sealing engagement at, and between, the open position and the closed position, with the valve bonnet at a first sealing diameter or periphery,

An exterior base of the valve member, when in the closed position, sealing against the valve body at a second sealing diameter or periphery,
the first sealing diameter or periphery greater than the second sealing diameter or periphery, a first pressure area defined between the first sealing diameter or periphery and the second sealing diameter or periphery, the first pressure area on receipt of fluid into the inner chamber under pressure providing a bias toward the closed position,
when in the open position an opening is defined between the valve body and valve member to allow fluid flow between the first port, via the opening to the second port,
a sensing spindle in sliding and sealing engagement with the valve bonnet at a third sealing diameter or periphery (D3), the third sealing diameter or periphery (D3) defining a second pressure area, the second pressure area on receipt of fluid under pressure providing a bias toward the open position,

Such that in use, the inlet fluid acting on the second pressure surface is subtractive to the first biasing force in sealing the first sealing surface to the inlet, and when the inlet pressure exceeds a set pressure, the sensing spindle is moved to, or toward, a second spindle position that breaks the seal at the first sealing diameter, and the inlet fluid can exit to the outlet.

Preferably the valve member biased closed by a first bias.

Preferably the first pressure area provides a bias from the fluid under pressure in addition to the first bias,

Preferably the third sealing diameter is less than the second sealing diameter.

Preferably there is a second bias acting on the sensing spindle in opposition to the inlet fluid acting on the second pressure surface.

In another aspect the present invention consists in a pressure relief valve with inlet and outlet ports, comprising or including,

A valve member located between the inlet and outlet ports, movable between an open position to allow a fluid flow between the ports, and closed position to prevent fluid flow,

The valve member in fluid communication with the inlet and outlet ports,

A movable sensing spindle in fluid communication with the inlet pressure and a reference pressure,

The sensing spindle having a first position, and a second position toward which it acts on the valve member to move it away from it's sealing position,

The valve member being in any position apart from it's sealing position would result in a fluid connection between the inlet and outlet.

In another aspect the present invention consists in a pressure relief valve to operate on an inlet fluid under pressure to prevent, and allow, the inlet fluid to flow from an inlet to an outlet, comprising or including,

A valve body having the inlet leading to an interior of the valve body, and the outlet exiting from the interior,

A valve member operatively located within the valve body, having a first pressure surface on a first side thereof in fluid communication with the inlet fluid, and a second pressure surface on a second side thereof, opposing the first surface, also in fluid communication with the inlet fluid, the difference in the first and second pressure surfaces defining a first pressure area on which the inlet and outlet pressures act, a first sealing surface on the first side to seal off the inlet from the outlet,
a first biasing force urging the valve member to a first valve position whereby it is sealing the inlet from the outlet,

A sensing spindle in fluid communication with the inlet, having a second pressure area in fluid communication with the inlet fluid, a second biasing force to urge the sensing spindle to a first spindle position against the inlet fluid pressure acting on the second pressure area, the second biasing force not additive to the first biasing force,

Such that in use, the differential pressure between the inlet and outlet fluid acting on the first pressure area is additive to the first biasing force in sealing the first sealing surface to the inlet, and

Wherein when the inlet pressure exceeds a set pressure, the sensing spindle via action of inlet pressure on the second pressure area is moved to, or toward, a second spindle position thereby acting on the valve member to create separation between the valve member and sealing surface and enable flow between the inlet and outlet.

Preferably when the sensing spindle acts on the valve member the sensing spindle moves the valve member to, or toward, a second valve position.

In another aspect the present invention consists in a pressure relief valve to operate on an inlet fluid under pressure to prevent, and allow, the inlet fluid to flow from an inlet to an outlet, comprising or including,

A valve body having the inlet leading to an interior of the valve body, and the outlet exiting from the interior,

A valve member operatively located within the valve body, having a first pressure area on which the inlet and outlet pressures act, a first sealing surface on the first side to seal off the inlet from the outlet,
a first biasing force urging the valve member to a first valve position whereby it is sealing the inlet from the outlet,

A sensing spindle in fluid communication with the inlet, having a second pressure area in fluid communication with the inlet fluid, a second biasing force to urge the sensing spindle to a first spindle position against the inlet fluid pressure acting on the second pressure area, the second biasing force not additive to the first biasing force,

Such that in use, the differential pressure between the inlet and outlet fluid acting on the first pressure area is additive to the first biasing force in sealing the first sealing surface to the inlet, and

Wherein when the inlet pressure exceeds a set pressure, the sensing spindle via action of inlet pressure on the second pressure area is moved to, or toward, a second spindle position thereby acting on the valve member to create separation between the valve member and sealing surface and enable flow between the inlet and outlet.

Preferably the valve member has a first pressure surface on a first side thereof in fluid communication with the inlet fluid, and a second pressure surface on a second side thereof, opposing the first surface, also in fluid communication with the inlet fluid, the difference in the first and second pressure surfaces defining the first pressure area.

In yet another aspect the present invention consists in a pressure relief valve to operate on an inlet fluid under pressure to prevent, and allow, the inlet fluid to flow from an inlet to an outlet, comprising or including,

A valve body having the inlet leading to an interior of the valve body, and the outlet exiting from the interior,

A valve member operatively located within the valve body, having a first pressure area on which the inlet and outlet pressures act, a first sealing surface on a first side thereof to seal against an inlet sealing surface and seal off the inlet from the outlet,
a first biasing force urging the valve member to a first valve position whereby it is able to seal the inlet from the outlet,

A sensing spindle in fluid communication with the inlet, having a second pressure area in fluid communication with the inlet fluid, a second biasing force to urge the sensing spindle to a first spindle position against the inlet fluid pressure acting on the second pressure area, the second biasing force not additive to the first biasing force,

Such that in use, the differential pressure between the inlet and outlet fluid acting on the first pressure area is additive to the first biasing force to seal off the inlet from the outlet, and

Wherein in use when the inlet pressure exceeds a set pressure, the sensing spindle via action of inlet pressure on the second pressure area, is moved to, or toward, a second spindle position thereby acting on the valve member to create separation between first sealing surface and the inlet sealing surface and enable fluid flow between the inlet and outlet.

Preferably there is a first pressure surface on a first side of the valve member in fluid communication with the inlet fluid, and a second pressure surface on a second side of the valve member, opposing the first pressure surface, also in fluid communication with the inlet fluid, the net difference in the first and second pressure surfaces defining the first pressure area on which the inlet and outlet pressures act.

Preferably the differential pressure between the inlet and outlet fluid acting on the first pressure area produces a net pressure force in addition to the first biasing force that acts to seal the valve member.

Preferably there is a third pressure surface on the sensing spindle which defines the second pressure area.

Preferably the separation of the first sealing surface and the inlet sealing surface, reduces a net force the first pressure area provides, such that the first sealing surface and the inlet sealing surface are further separated by the sensing spindle to enable flow between the inlet and outlet.

Preferably the first and or second bias is adjustable.

Preferably the first bias is a spring or other elastic or similar bias that can provide initial force to hold the first sealing surface against the inlet sealing surface

Preferably the sensing spindle is substantially contained within the valve member.

Preferably the area of the second pressure surface is greater than the area of the first pressure surface to increase the force holding the valve member sealed.

Preferably the ratio of the area of the first pressure surface to the second pressure surface can be adjusted through the inlet to vary the energising force closing the valve member.

Preferably there is an annular chamber about the valve member in fluid communication with the outlet.

Preferably the second pressure area, or pressure surface of the spindle is used to overcome the combined closing force of the first bias and the resultant force of the first pressure area and the inlet and outlet pressures acting on it to move the valve member from the first valve position and unseal the valve member.

Preferably the valve member is an annular member, with the first sealing surface proximal the inlet.

Preferably the first sealing surface is an annular surface.

Preferably the inlet sealing surface is annular to mate to the first sealing surface.

Preferably there is at least one fluid channel between the first pressure surface and the second pressure surface.

Preferably the fluid channel is within a periphery of the first sealing surface, such that when the first sealing surface is sealed to the inlet sealing surface there is no fluid communication to the outlet.

Preferably the first biasing force is provided by a coil spring located about an external surface of the valve member.

Preferably the second biasing force is provided by a coil spring.

Preferably there is a stop to hold the sensing spindle in the first spindle position against the second biasing force.

Preferably the second bias is adjustable in its force to allow, in part, adjustment of the set pressure.

Preferably as inlet fluid pressure increases, but remains below the set pressure, the first pressure area increases the force holding valve member sealed.

Preferably the at least one fluid channel is at an axial centre of the valve member and the sensing spindle passes therethrough toward the inlet.

Preferably the sensing spindle and valve member translate from their first respective positions to their second respective positions along a longitudinal axis.

Preferably the annular member defining the valve member, first sealing surface, and inlet sealing surface are concentric with the longitudinal axis.

Preferably there are additional fluid channels between the first pressure area and second pressure area.

Preferably a cross-section of the sensing spindle upstream from the valve member can act as a catch to engage and open the valve member as the sensing spindle moves from its first position to, or towards, its second position.

Preferably the cross section is of greater diameter than the fluid channel the sensing spindle passes through to enable the sensing spindle to engage and move the valve member.

Preferably the stop also acts to form the annular chamber and is sealed to an inner perimeter thereof.

Preferably the sensing spindle and the valve member are in separate sliding sealing with the stop.

Preferably the sensing spindle has a stop portion to engage with the stop to hold the sensing spindle in the first spindle position against the second biasing force.

Preferably there is a guide skirt on the valve member, extending to, or into the inlet, and in sliding engagement therewith, to guide the valve member as it seals and unseals.

Preferably the guide skirt is in sliding sealing engagement with the inlet.

Preferably the fluid channels are unsealed in a first movement of the valve member toward the second valve position, and the valve skirt, or a second fluid channel thereof, is unsealed in a second further movement of the valve member towards the second valve position.

Preferably the valve member is balanced with respect to both inlet and outlet pressures.

In another aspect the present invention consists in a method of operating a pressure relief valve to operate on an inlet fluid under pressure to prevent, and allow, the inlet fluid to flow from an inlet to an outlet, comprising or including,

Biasing a valve member to seal an opening from the inlet to the outlet, the valve member having a first pressure area which the inlet fluid pressure can act on to increase the sealing force of the valve member onto a seat in addition to the valve member bias to seal the inlet from the outlet,

Biasing a sensing spindle against inlet fluid pressure from the inlet acting on a second pressure area of the sensing spindle, the sensing spindle bias not adding to the valve member bias, the sensing spindle bias providing a set pressure under which the sensing spindle does not move, wherein,

Below the set pressure the sensing spindle is not in contact with valve member, the valve member bias and inlet pressure on the first pressure area hold the valve element sealed, and the sensing spindle bias holds the sensing piston against a hard stop,

Nearing the set pressure the valve member is forced harder into it's seat by action of the first pressure area,

Just below the set pressure the sensing spindle, independent of the valve member, moves towards and contacts the presently static valve member, but the inlet pressure is not enough to overcome the valve member bias and first pressure area force on the valve member,

Once the set pressure is reached the inlet fluid pressure on the second pressure area, being greater than the first pressure area, is now high enough to overcome both the valve member bias and sensing spindle bias, the sensing spindle then moves the valve member to unseal the opening, and allow fluid flow between the inlet and outlet,
such that a pressure relief valve is provided that has low initial sealing pressure and which sealing pressure increases with inlet fluid pressure preventing inlet fluid flow to the outlet, until the set pressure is reached at which point the opening is unsealed to allow fluid flow from the inlet to the outlet.

In another aspect the present invention consists in a method of operating a pressure relief valve to operate on an inlet fluid under pressure to prevent, and allow, the inlet fluid to flow from an inlet to an outlet, comprising or including,

Biasing a valve member to seal an opening from the inlet to the outlet, the valve member having a first pressure area which the inlet fluid pressure can act on to increase the sealing force of the valve member onto a seat in addition to the valve member bias to seal the inlet from the outlet,

Biasing a sensing spindle against inlet fluid pressure from the inlet acting on a second pressure area of the sensing spindle, the sensing spindle bias not adding to the valve member bias, the sensing spindle bias providing a set pressure under which the sensing spindle does not move, wherein,

Below the set pressure the sensing spindle is not in contact with valve member, the valve member bias and inlet pressure on the first pressure area hold the valve element sealed, and the sensing spindle bias holds the sensing spindle against a hard stop,

Once the set pressure is reached the inlet fluid pressure on the second pressure area, being greater than the first pressure area, is now high enough to overcome both the valve member bias and sensing spindle bias, the sensing spindle then moves the valve member to unseal the opening, and allow fluid flow between the inlet and outlet,
such that a pressure relief valve is provided that has low initial sealing pressure and which sealing pressure increases with inlet fluid pressure preventing inlet fluid flow to the outlet, until the set pressure is reached at which point the opening is unsealed to allow fluid flow from the inlet to the outlet.

Preferably Just below the set pressure the sensing spindle, independent of the valve member, moves towards and contacts the presently static valve member, but the inlet pressure is not enough to overcome the valve member bias and first pressure area force on the valve member.

Preferably there is a first pressure surface on a first side of the valve member in fluid communication with the inlet fluid, and a second pressure surface on a second side of the valve member, opposing the first pressure surface, also in fluid communication with the inlet fluid, the net difference in the first and second pressure surfaces defining the first pressure area on which the inlet and outlet pressures act.

Preferably the differential pressure between the inlet and outlet fluid acting on the first pressure area produces a net pressure force in addition to the first biasing force that acts to seal the valve member.

Preferably there is a third pressure surface on the sensing spindle which defines the second pressure area.

Preferably the separation of the first sealing surface and the inlet sealing surface, reduces a net force the first pressure area provides, such that the first sealing surface and the inlet sealing surface are further separated by the sensing spindle to enable flow between the inlet and outlet.

Preferably the first and or second bias is adjustable.

Preferably the first bias is a spring or other elastic or similar bias that can provide initial force to hold the first sealing surface against the inlet sealing surface Preferably the sensing spindle is substantially contained within the valve member.

Preferably the area of the second pressure surface is greater than the area of the first pressure surface to increase the force holding the valve member sealed.

Preferably the ratio of the area of the first pressure surface to the second pressure surface can be adjusted through the inlet to vary the energising force closing the valve member.

Preferably there is an annular chamber about the valve member in fluid communication with the outlet.

Preferably the second pressure area, or pressure surface of the spindle is used to overcome the combined closing force of the first bias and the resultant force of the first pressure area and the inlet and outlet pressures acting on it to move the valve member from the first valve position and unseal the valve member.

Preferably the valve member is an annular member, with the first sealing surface proximal the inlet.

Preferably the first sealing surface is an annular surface.

Preferably the inlet sealing surface is annular to mate to the first sealing surface.

Preferably there is at least one fluid channel between the first pressure surface and the second pressure surface.

Preferably the fluid channel is within a periphery of the first sealing surface, such that when the first sealing surface is sealed to the inlet sealing surface there is no fluid communication to the outlet.

Preferably the first biasing force is provided by a coil spring located about an external surface of the valve member.

Preferably the second biasing force is provided by a coil spring.

Preferably there is a stop to hold the sensing spindle in the first spindle position against the second biasing force.

Preferably the second bias is adjustable in its force to allow, in part, adjustment of the set pressure.

Preferably as inlet fluid pressure increases, but remains below the set pressure, the first pressure area increases the force holding valve member sealed.

Preferably the at least one fluid channel is at an axial centre of the valve member and the sensing spindle passes therethrough toward the inlet.

Preferably the sensing spindle and valve member translate from their first respective positions to their second respective positions along a longitudinal axis.

Preferably the annular member defining the valve member, first sealing surface, and inlet sealing surface are concentric with the longitudinal axis.

Alternatively the annular member defining the valve member, first sealing surface, and inlet sealing surface are not concentric with the longitudinal axis as they seal on flat surfaces.

Preferably there are additional fluid channels between the first pressure area and second pressure area.

Preferably a cross-section of the sensing spindle upstream from the valve member can act as a catch to engage and open the valve member as the sensing spindle moves from its first position to, or towards, its second position.

Preferably the cross section is of greater diameter than the fluid channel the sensing spindle passes through to enable the sensing spindle to engage and move the valve member.

Preferably the stop also acts to form the annular chamber and is sealed to an inner perimeter thereof.

Preferably the sensing spindle and the valve member are in separate sliding sealing with the stop.

Preferably the sensing spindle has a stop portion to engage with the stop to hold the sensing spindle in the first spindle position against the second biasing force.

Preferably there is a guide skirt on the valve member, extending to, or into the inlet, and in sliding engagement therewith, to guide the valve member as it seals and unseals.

Preferably the guide skirt is in sliding sealing engagement with the inlet.

Preferably the fluid channels are unsealed in a first movement of the valve member toward the second valve position, and the valve skirt, or a second fluid channel thereof, is unsealed in a second further movement of the valve member towards the second valve position.

Preferably the valve member is balanced with respect to both inlet and outlet pressures.

In another aspect the present invention consists in a method of operating a pressure relief valve to operate on an inlet fluid under pressure to prevent, and allow, the inlet fluid to flow from an inlet to an outlet, comprising or including,

Providing a valve body having the inlet leading to an interior of the valve body, and the outlet exiting from the interior,

Providing a valve bonnet removably engaged to the valve body between the first port and the second port, to further define a duct therebetween,

Providing a valve member having an endless skirt within the duct, the endless skirt having an outer periphery, which the valve body at least in part defines an annular chamber about, and the endless skirt having an inner periphery which defines an inner chamber, the valve member having a closed position to prevent flow of fluid, and an open position to allow flow of fluid,
the endless skirt in sliding and sealing engagement at, and between, the open position and the closed position, with the valve bonnet at a first sealing diameter or periphery,

Providing an exterior base of the valve member, when in the closed position, sealing against the valve body at a second sealing diameter or periphery,
the first sealing diameter or periphery greater than the second sealing diameter or periphery, a first pressure area defined between the first sealing diameter or periphery and the second sealing diameter or periphery, the first pressure area on receipt of fluid into the inner chamber under pressure providing a bias toward the closed position,
when in the open position an opening is defined between the valve body and valve member to allow fluid flow between the first port, via the opening to the second port,

Providing a sensing spindle in sliding and sealing engagement with the valve bonnet at a third sealing diameter or periphery (D3), the third sealing diameter or periphery (D3) defining a second pressure area, the second pressure area on receipt of fluid under pressure providing a bias toward the open position,

Such that in use, the inlet fluid acting on the second pressure surface is subtractive to the first biasing force in sealing the first sealing surface to the inlet, and when the inlet pressure exceeds a set pressure, the sensing spindle is moved to, or toward, a second spindle position that breaks the seal at the first sealing diameter, and the inlet fluid can exit to the outlet.

In another aspect the present invention consists in a method of operating pressure relief valve with inlet and outlet ports, comprising or including,

Providing a valve member located between the inlet and outlet ports, movable between an open position to allow a fluid flow between the ports, and closed position to prevent fluid flow,

The valve member in fluid communication with the inlet and outlet ports,

Providing a movable sensing spindle in fluid communication with the inlet pressure and a reference pressure,

Allowing the sensing spindle to move between a first position, and a second position toward which it acts on the valve member to move it away from it's sealing position,

The valve member being in any position apart from it's sealing position would result in a fluid connection between the inlet and outlet.

In another aspect the present invention consists in a pressure relief valve as described herein with reference to any one or more of the accompanying drawings.

In another aspect the present invention consists in a method of operating a pressure relief valve as described herein with reference to any one or more of the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF THE DRAWINGS

Preferred forms of the present invention will now be described with reference to the accompanying drawings in which;

FIG. 1 Shows a side isometric view of a pressure relief valve in keeping with the present invention,

FIG. 2 Shows a front isometric view of a pressure relief valve of FIG. 1, showing some of the internals through the valve outlet,

FIG. 3 Shows a bottom isometric view of a pressure relief valve of FIG. 1, showing some of the internals through the valve inlet,

FIG. 4 Shows a side vertical cross section of the valve of FIG. 1,

FIG. 5 Shows a close up of the upper region of the cross section of FIG. 4,

FIG. 6 Shows a close up of the lower regions of the cross section of FIG. 4,

FIG. 7 Shows an exploded view in isometric of the valve of FIG. 1,

FIG. 8 Shows a close up of the upper region of the exploded view of FIG. 7,

FIG. 9 Shows a close up of the lower region of the exploded view of FIG. 7,

FIG. 10 Shows a schematic of the internal components and operation of the valve in keeping with the present invention,

FIG. 11 Is a graph of pressure verses sensing piston displacement for the present invention compared to two prior art pressure release valves,

FIG. 12 Is a graph of pressure verses valve seating force for the present invention compared to two prior art pressure release valves,

FIG. 13 Shows the lower valve interior with the valve body removed prior to reaching the set release pressure,

FIG. 14 Shows the view of FIG. 13 where the valve has initiated opening due to reaching the set pressure,

FIG. 15 Shows the view of FIG. 13 where the valve is now fully or near fully open and is release the pressure as the set release pressure has been reached,

FIG. 16 Shows a cross sectional schematic of the pressure release valve,

FIG. 17 Shows a further cross section having a bellowed sealing,

FIG. 18 Shows a further variation of the present invention in vertical cross section along the main axis

FIG. 19 Shows a vertical cross section of a further variation of the present invention utilising flat sealing interfaces between the valve member and valve body, and an encased first bias for the valve member, the valve being in the closed position,

FIG. 20 Shows a similar view to that of FIG. 19 showing the resulting forces from the inlet fluid pressure acting on the sensing spindle and valve member, the valve is still closed,

FIG. 21 Shows a similar view to that of FIG. 19 where the sensing spindle has moved up to contact the valve member,

FIG. 22 Shows a similar view to that of FIG. 21 where the sending spindle has engaged the valve member and inlet pressure has risen to the point where the valve member is opened and fluid pressure is relieved from the inlet to the outlet.

### DETAILED DESCRIPTION OF THE INVENTION

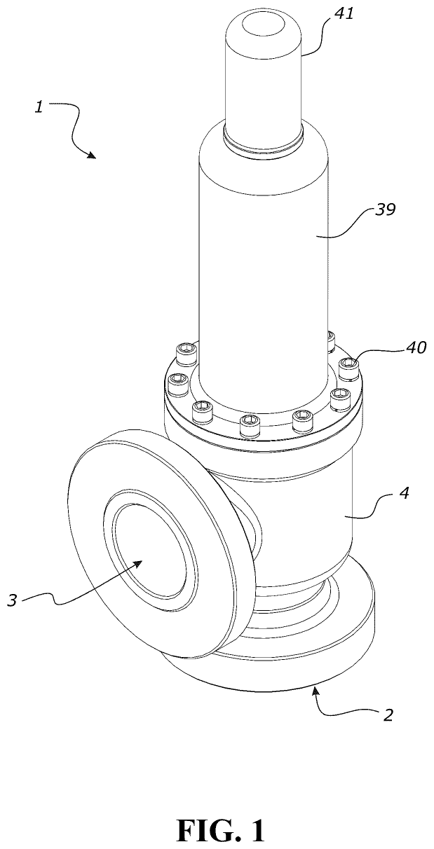

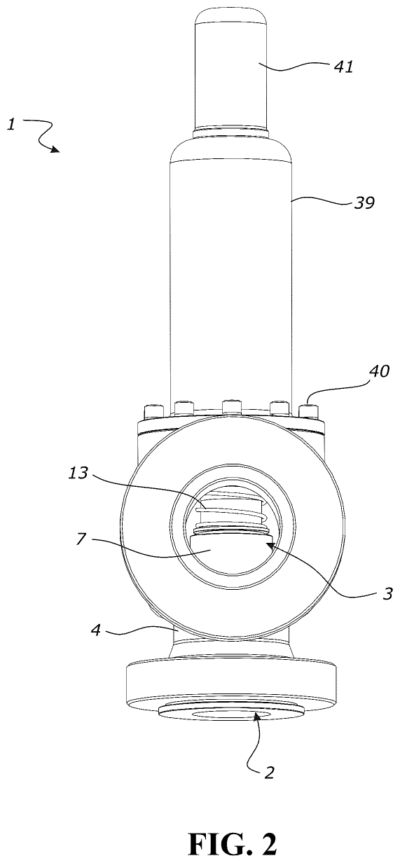

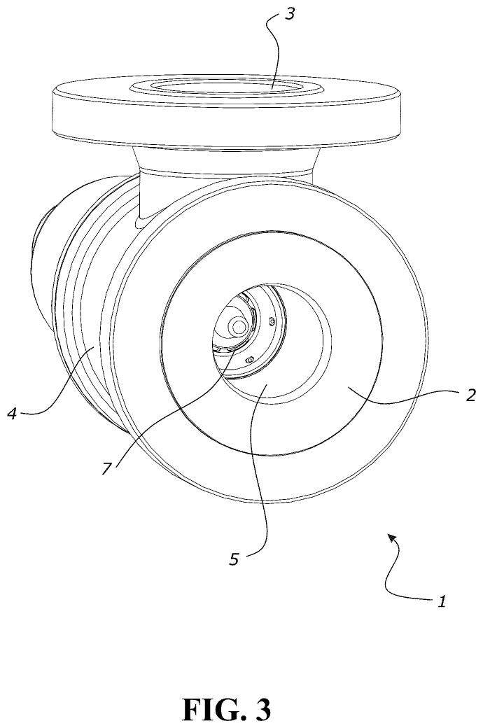

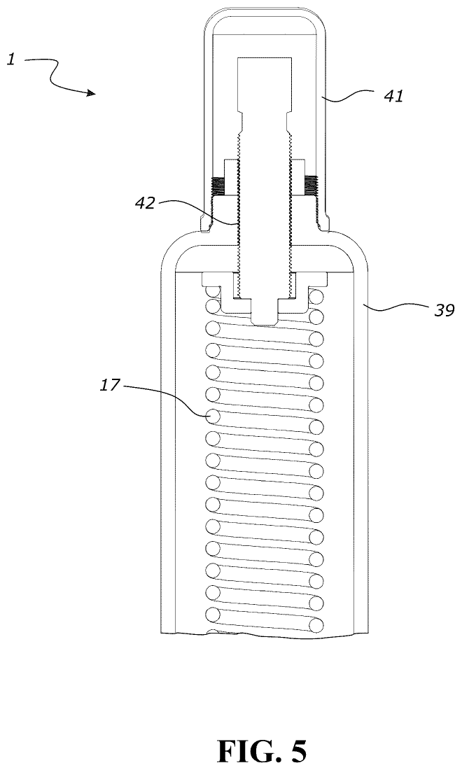

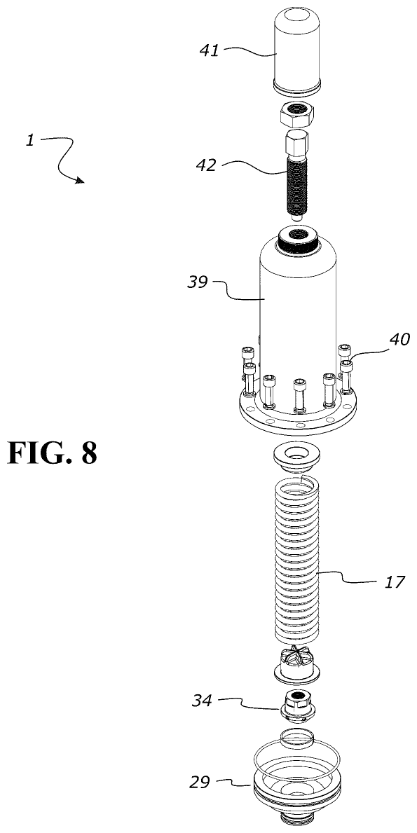

Preferred embodiments will now be described with reference to FIGS. 1 through 18.

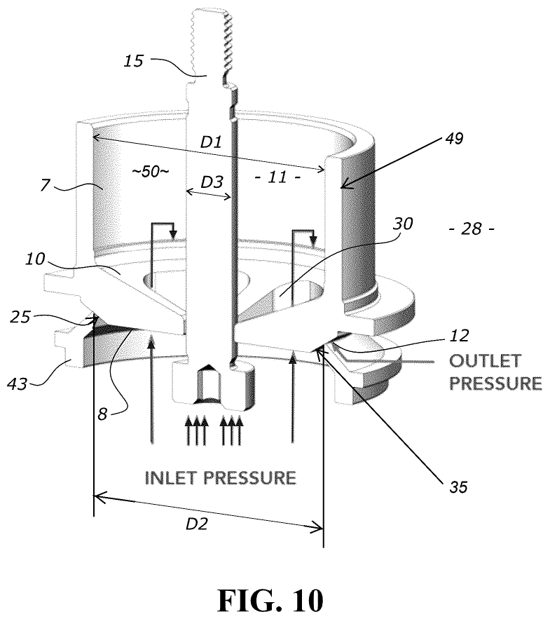

A first variation of the pressure relief valve 1 is shown in FIGS. 1 to 9, and its principal of operation in FIGS. 10 through 15. The valve 1 shown generally in FIG. 1 has a valve body 4 and an inlet 2 into an interior 5 of the valve body 4, and an outlet 3 from the interior 5. Connected to the valve body 4 is a bonnet 39. The bonnet 39 can be attached in any number of ways to the valve body 4, and in the variations shown here bonnet fasteners 40 as threaded bolts pass through the bonnet 39 into threaded portions in the valve body 4 and hold the two together. Inside the valve bonnet 39 there is contained a second bias 17 for the sensing spindle 15, which is explained in more detail below.

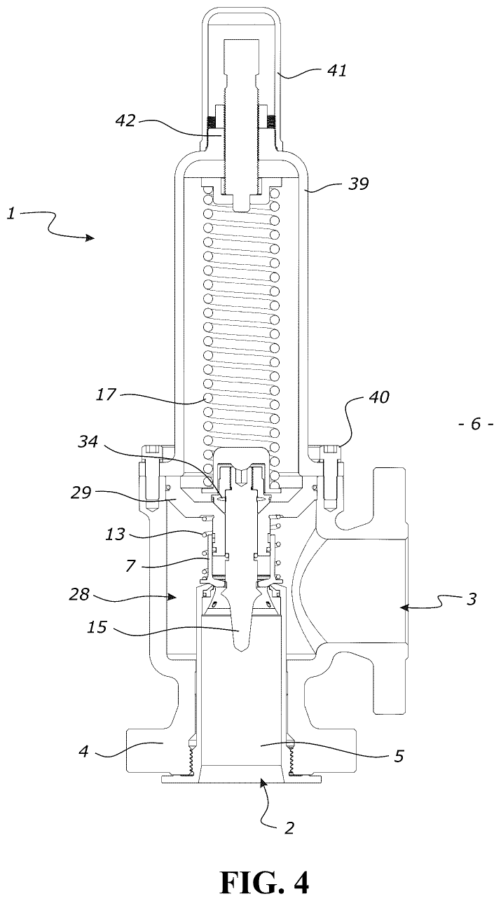

On top of the bonnet 39, there is a bonnet cap 41, shown in FIGS. 4, 5, 7 and 8. The bonnet cap 41 may attach in any desired way, from a press-fit, to bayonet, to threaded or otherwise. Optionally, though not ideally there is no bonnet cap 41, though this may allow corrosion and contamination of the components that would otherwise be covered. For an adjustable bias 17 the bonnet cap covers the second bias adjustor 42, the form of the adjustment 42 will depend on the bias selected. In the variation shown the bias 17 is a coil spring acting in compression against the sensing spindle 15. The adjustment 42 in this case is a threaded rod that engages a nut or similar threaded component in the bonnet 39 or bonnet cap 41. Optionally there may be a lock nut (not shown) to prevent vibration or otherwise varying the adjustor. The adjustor 42 will advance or retract relative to the bias 17 and therefore increase or decrease respectively the force the spring 17 applies to the sensing spindle 15, thus adjusting the set point (discussed further below). Other methods to adjust a spring bias may also be used, such as a rotating crown with differing step heights. The bias may take any one of a number of other forms also that are applicable to produce an increased or reduced force on the sensing spindle, such as, but not limited to, passive compressive or tensile springs, gas or air driven springs, or electro-mechanical systems.

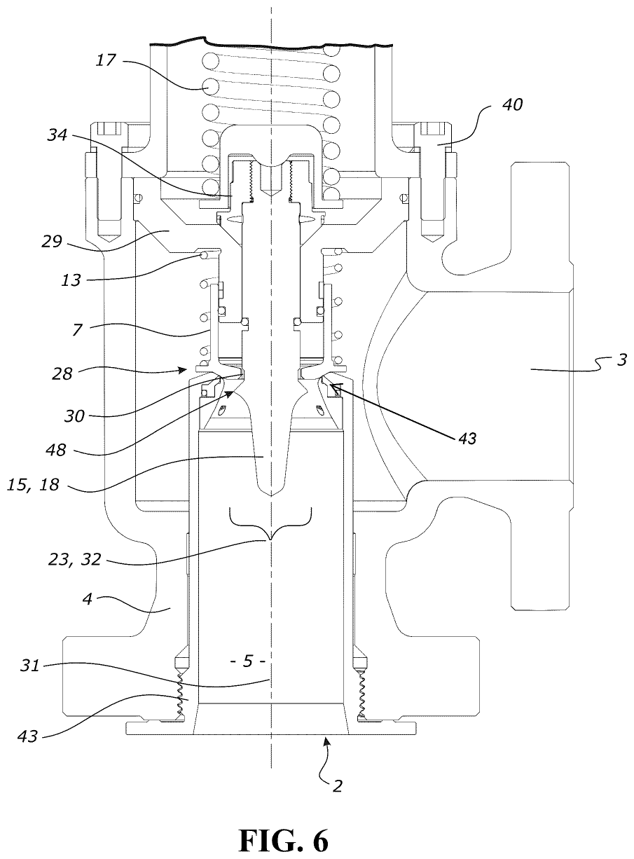

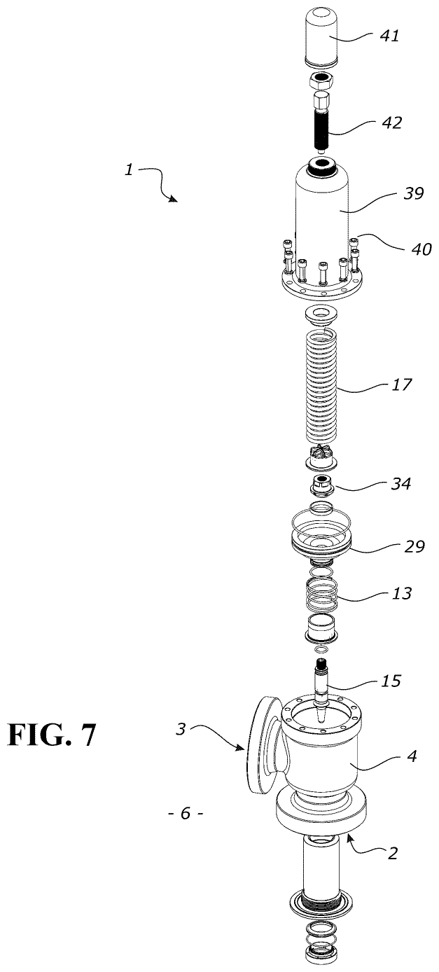

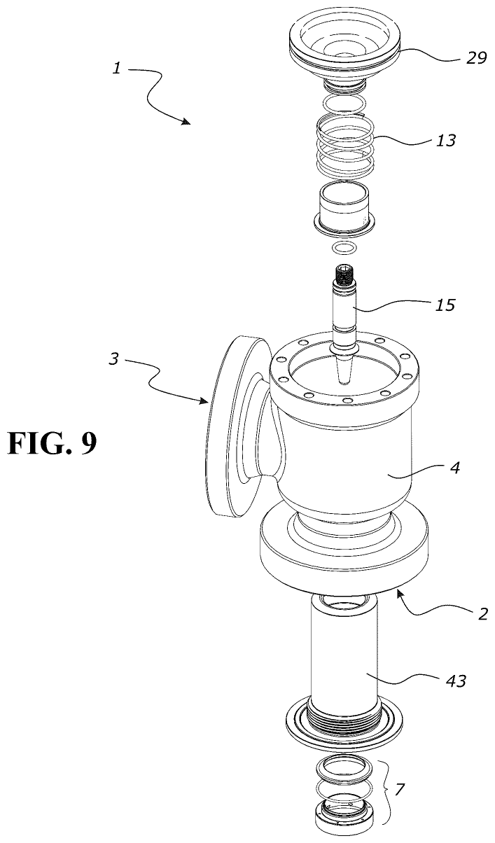

A close up of the interior 5 of the valve body is shown in FIG. 6, and in exploded form in FIGS. 7 and 9. The interior 5 houses the valve member 7, sensing spindle 15 and first bias 13. The valve member 7 as shown is an annular or circular shape about the longitudinal axis 31, and the sensing spindle 15 lies on that axis 31 also, and both slide along that axis independently. The valve member 7 and sensing spindle 15 are radially symmetric, so they are intrinsically balanced laterally when pressure is applied and stay parallel in their movement.

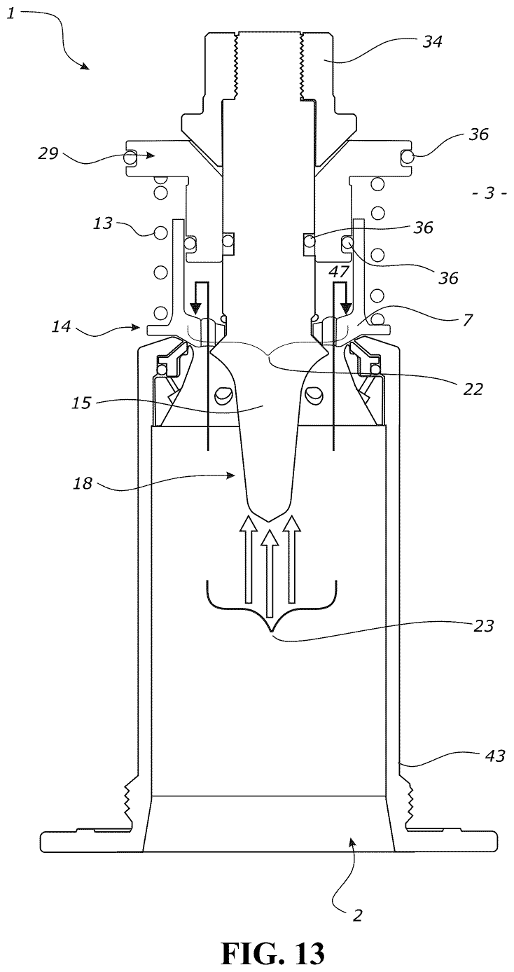

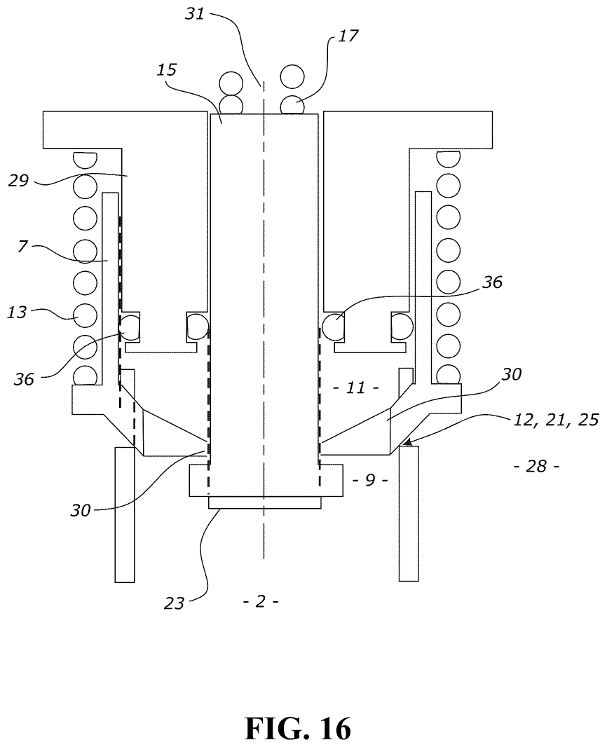

The valve member 7 is energised to its first valve position 14 shown in FIG. 6 by the first bias 13. This creates the initial seal 21 (shown in FIG. 16) of the inlet 2 from the chamber 28 (preferably annular) which in turn leads to the outlet 3. The first sealing surface 12, shown in FIG. 10, of the valve member 7 seals 21 against the inlet sealing surface 25. In this example there is a a first sealing surface 12—in the variation shown in FIG. 13 through 15 there is an inlet insert 43 that holds the inlet sealing surface 25. In this variation the inlet insert 43 is threaded and sealed to the valve body 4, however any suitable method of retention and sealing may be used, such as, but not limited to, interference fit, adhesives or similar.

The valve member 7 has one or more fluid channels 30 from the first pressure surface 8 on the first side 9 to the second pressure surface 11 on the second side 11 as shown in FIGS. 10 and 16. These allow the inlet pressure to act on both the first and second sides of the valve member 7, and form the net first pressure area that in conjunction with the inlet fluid pressure and outlet fluid pressure acts to increase the force on the seal 21 as the inlet pressure increases.

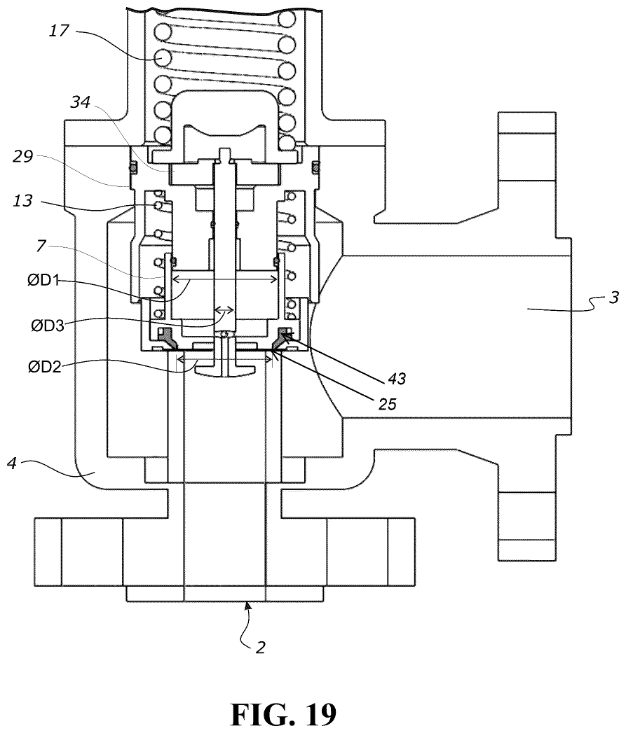

A first pressure area 23 is determined by the net area of the sensing spindle 15 facing the fluid pressure in the inlet 2, as shown in FIGS. 10, 13 and 19 and is defined by diameter or periphery D3. The second pressure area 22 is the net difference between the areas of the first pressure surface 8 on the first side 9, for example defined by diameter or periphery D2 in FIGS. 10 and 19, and the second pressure surface 10 of the second side 11 of the valve member 7, defined by diameter or periphery D1 in FIGS. 10 and 19, the diameter or periphery D1 is greater than diameter or periphery D2. Because the second pressure surface 10 is greater than the first pressure surface 8, there is a net closing force 47 the valve member 7 when the valve member is closed, this net closing force in FIG. 13 is forcing the valve member 7 downwards, in the arrowed direction shown.

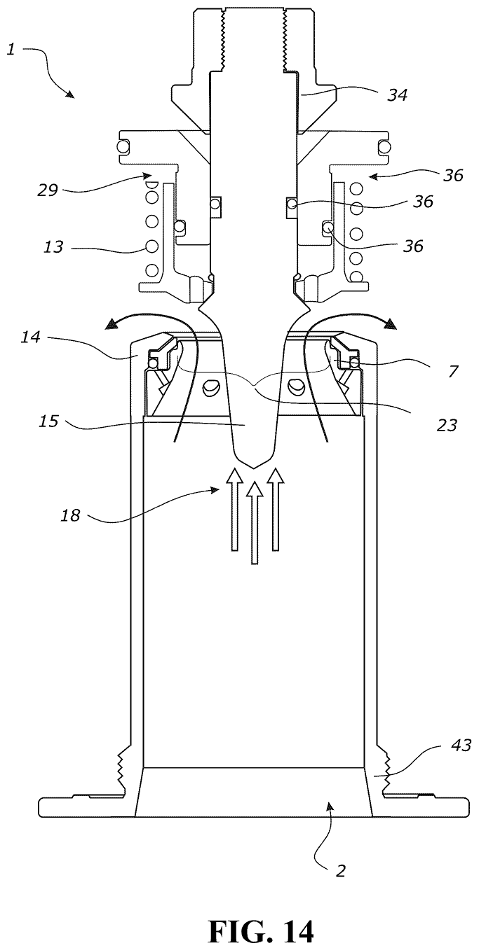

The valve member 7 is in sliding sealing engagement within the valve 1 such that the only path to the outlet 3, even from the second side 11 is via the opening the valve member 7 forms between the first sealing surface 12 and inlet sealing surface 25 when the valve member is moving from the first valve position 14 (shown in FIGS. 10 and 13 for example) to, or towards the second valve position 24 (shown in FIG. 14 for example). In the variation shown in FIG. 6 there is a stop 29 that acts to form a sliding seal with the valve member 7 in this manner, and also cages or guides the first bias 13 between itself and the valve member 7. The stop 29 in this variation is held in place by a relief in the valve body 4 and the valve bonnet 39 above.

The stop 29 also acts as stop for the second bias 17 that acts on the sensing spindle 15, as seen in FIG. 6, via the second bias 17 acting through a stop portion 34 that engages between the stop 29 and second bias 17, and moves with the second bias 17 and sensing spindle 15. The sensing spindle 15 presents a second pressure area 23 to the pressure of the inlet fluid.

As can be seen and understood from the above description the first bias 13 and second bias 17 are independent and do not act on each other.

The sensing spindle 15 is energised and held in its first spindle position 18 by the second bias 17, and is guided to stay parallel to the axial centre 31 by passing through the middle of the stop 29 as shown in FIG. 6. Through one of the fluid apertures 30 in the variation in FIGS. 1 to 17 the sensing spindle 15 fluid passes, as shown at least in FIGS. 6 and 10.

The sensing spindle 15 as noted can engage the valve member 7 to move it and crack the valve member 7 open. The sensing spindle 15 has a shoulder 48 (which is on the backside in this embodiment of the second pressure area 23). In this embodiment it is the shoulder 48 that engages the valve member 7 to move and open it.

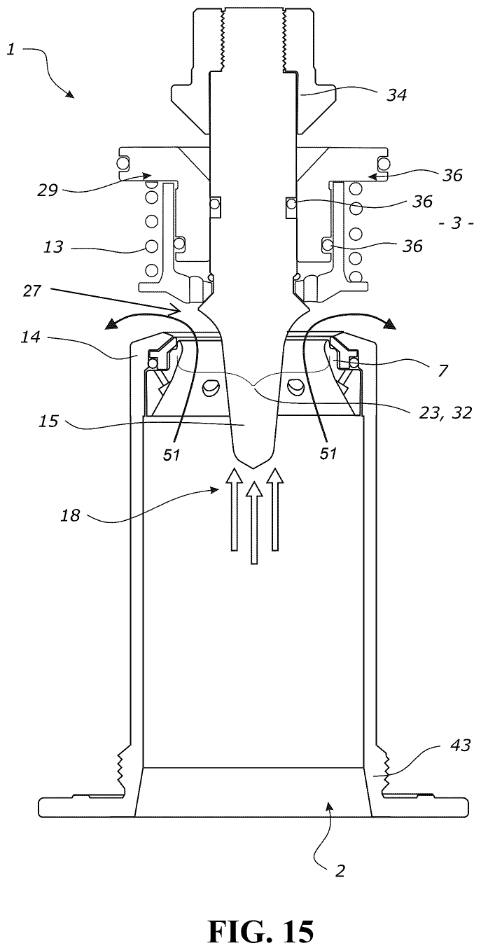

The sensing spindle 15 can move from its first spindle position 18 (shown in FIG. 6), to or towards the second spindle position 20 (shown in FIG. 15). In the preferred variation partway through this motion the sensing spindle 15 will engage the valve member 7. This is achieved by the cross section 32 being wider than the central fluid channel 30 of the valve member 7 through which it passes as seen in FIGS. 6 and 15. The sensing spindle may engage the valve member in any other way that contacts and moves the valve member 7 as a result of the movement of the sensing spindle toward the second spindle position 20, thus moving the valve member 7 to and toward the second valve position 24, and its fully open state.

Through the movement of the sensing spindle and valve member the stop 29 does not move.

The pressure relief valve 1 when not in use, either on the shelf in storage, or connected but not receiving a net higher inlet pressure has a very low sealing force, due to only the first bias 13 acting. This preserves the sealing materials as no seals or sealing interfaces (e.g. valve first sealing surface 12 of valve with inlet sealing surface 25) are under very low static load. Sealing load only increases proportional to the net difference between the inlet and outlet fluid pressures.

The valve member 7 or sensing spindle 15 must preferably be guided in it's movement, and can either be guided in its movement on the valve bonnet 39, the nozzle, or the sensing spindle, on internal or external faces of each. The guidance features and the shape of those elements may be such that the flow capacity of the valve is throttled or otherwise augmented via the position of the valve.

As an example of this the valve member 7 may have an extension as a skirt (not shown) extending from the lower periphery of the first pressure surface 8 (see FIG. 10) down into the inlet 2, and engages with the interior perimeter of the inlet/seal through the range of motion from the first valve position 14 to the second valve position 24. The skirt, if present, can provide stability laterally for, and guide, the valve member 7. Apertures through the skirt will still allow flow of fluid from the inlet to the outlet when moved from the first valve position 14. Such a skirt may aid in throttle discharge rate on initial opening.

Fluid channels 30 may also be present diagonally through the valve member 7 from the second pressure surface 10 to the first pressure surface 8 and are angled toward the outlet such that they allow initial release of inlet fluid pressure from behind the valve member when initially displaced from the first valve position 14, such as when the valve member is in simmer, ie when just releasing fluid pressure. In one form these fluid passages may seal against the inlet sealing surface 25. These fluid passages may be the first path for release of inlet fluid pressure on initial movement of the valve member from the first valve position, until deeper into the movement toward the second valve position 24.

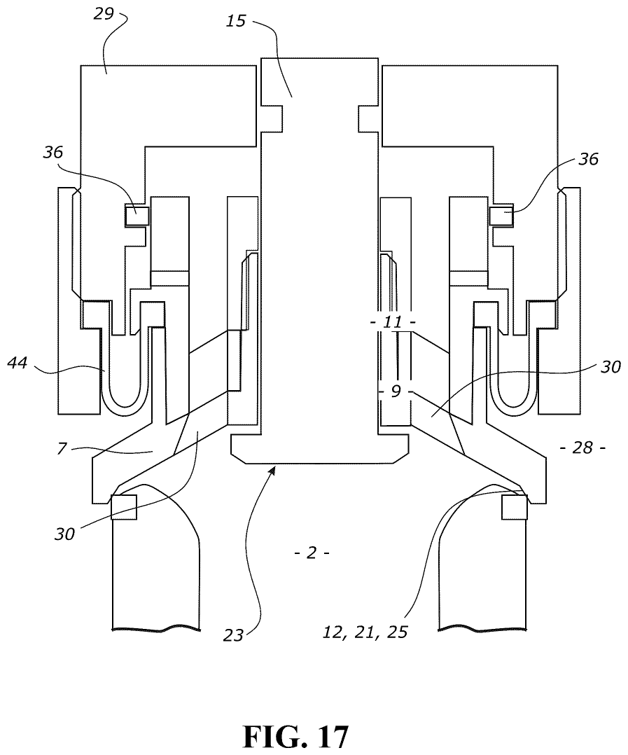

FIG. 17 shows a variation of the valve 1 that uses a bellows or rolling seal 44 between the valve member 7 and the valve body.

In a preferred variation of the invention, shown for example in FIG. 19, the removal of the valve bonnet 39, will allow extraction of the stop 29, sensing spindle 15, valve member 7, spring 13 and inlet insert 43 all as a subassembly or cartridge. This allows for ease of serviceability—a new bonnet sub-assembly can be installed into the valve body 4, which can be left in situ. Thus a failed valve, or valve maintenance can be easily achieved through removal of the existing subassembly, and insertion of a new one. The existing sub-assembly can then be serviced as needed. The extractable cartridge or subassembly incorporates all replaceable and serviceable components. The cartridge or subassembly incorporates all soft seals and moving components which can be removed as one unit which dramatically improves serviceability compared to the prior art.

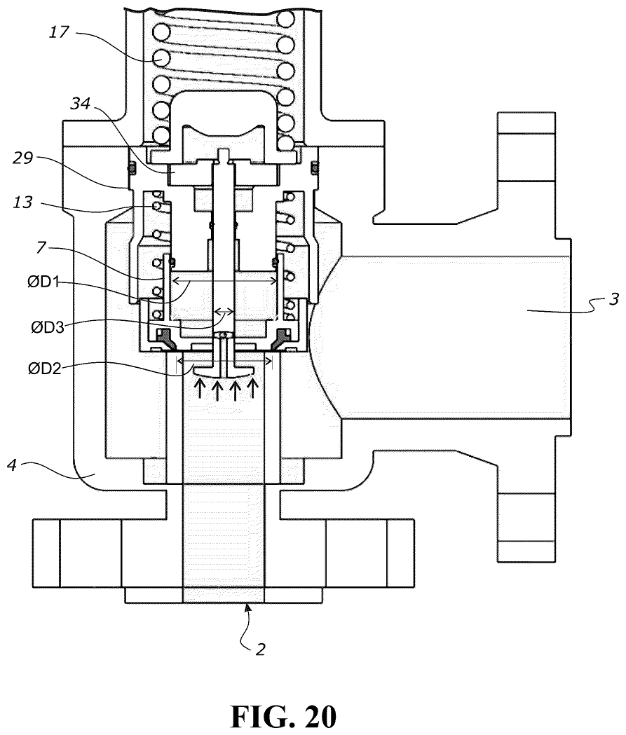

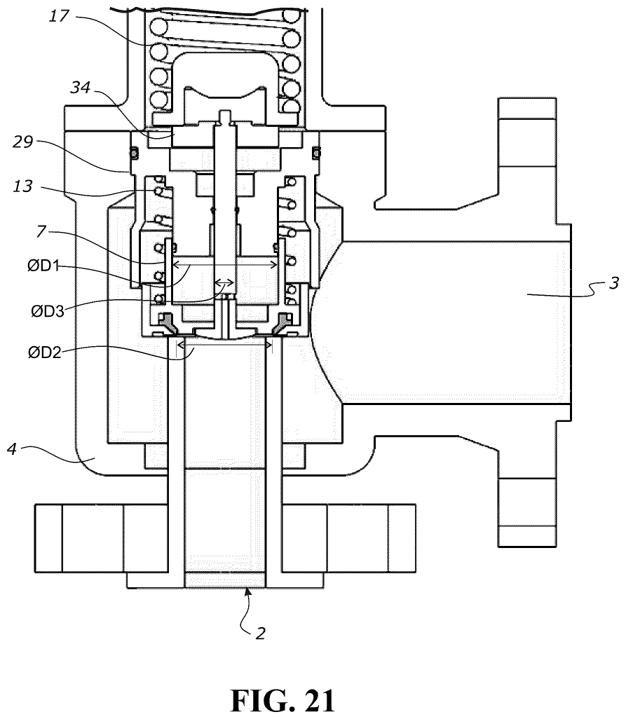

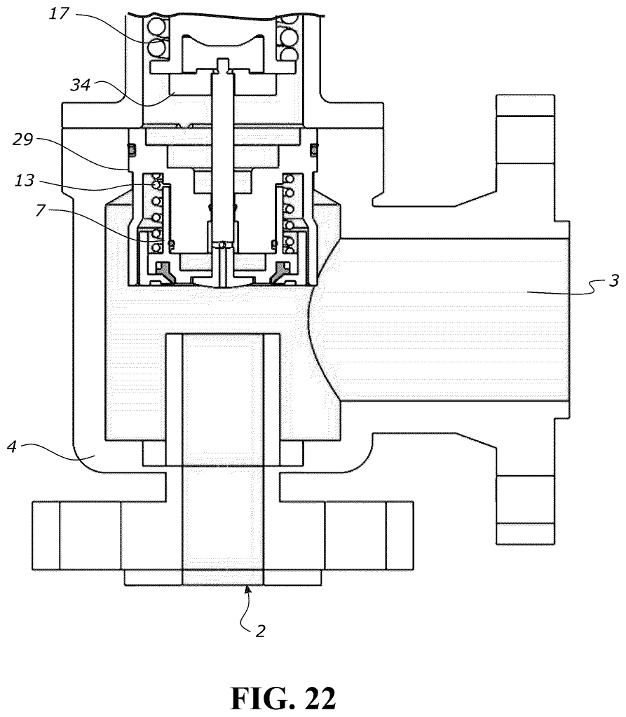

A further variation incorporating the same operation and features of the invention is shown in FIG. 19 through 22. In the variation the first bias 13 is protected from the fluid as it passes from the inlet when the valve member 7 opens by and overlap of the stop 29 and the valve member 7 which largely or completely encapsulates the bias 13. The opening of the valve member 7 may be quite a sudden and violent pressure event and release and this this protects them from corrosion, corrosive properties or particles therein. This is beneficial when as the valve member and spring 13 are no longer exposed to high velocity turbulent flow and now will conform to the requirements set out in ASME VIII.

This further variation has flat surfaces sealing surfaces. The flat, for example polished surface of the nozzle or inlet insert 43 and sealing surface 25 between it and the valve member 7 provides sufficient sealing surface area to allow tolerances (particularly concentricity requirements) to be relaxed. An added benefit of this variation is that pressure areas and therefore the performance of the valve is not dependant on where the face seal makes contact on the inlet insert 43; misalignment due to tolerances does not affect pressure biases. Misalignment of the face seal diameter or periphery, piston permanent seal and sensing spindle seal in relationship with each other have no effect on the pressure bias system and performance of the valve. It is the dimensional/geometric tolerances of their diameters or periphery that have a direct effect, that is the pressure areas as previously defined.

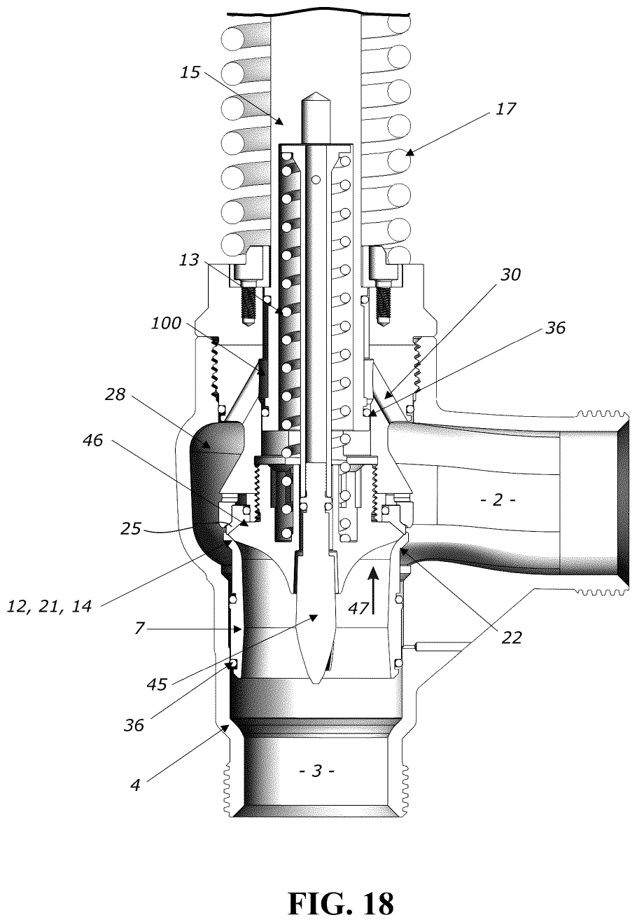

The pressure relief valve 1 of the present invention may be described by way of pressure areas, defined by a perimeter or diameter (or other dimensions if a non-circular arrangement is used). In this way the pressure relief valve operates to prevent flow of fluid from an inlet (or first port) 2 to an outlet (or second port) 3 until the difference in pressure between the inlet 2 and the outlet 3 reaches a set point. The inlet 2 of the valve body leads to an interior of the valve body, and the outlet 3 exits from the interior, as shown not least of all in FIGS. 4, 10, 13 and 19. There is a valve bonnet 39 removably engaged to the valve body, for example using fasteners 40 in FIG. 4, but a threaded interface may also be used as in FIG. 18. The valve body and bonnet 40 define a duct or chamber 28, which in the examples shown is annular or toroidal (that is donut shaped) therebetween. The valve member 7 has an endless valve skirt 49 (such as indicated in FIG. 10) or wall within the duct or chamber 28. The endless skirt 49 has an outer periphery which in the examples shown is circular, but could be of any shape, and the valve body 4 at least in part defines the annular chamber 28. The endless skirt 49 has an inner periphery which defines an inner chamber 50. The valve member 7 has a closed position to prevent flow of fluid, and an open position to allow flow of fluid, the valve member biased closed by a first bias 13. The endless skirt 49 is in sliding and sealing engagement at, and between, the open position and the closed position, with the valve bonnet at a first sealing diameter or periphery D1 (shown in FIG. 10 as the interior diameter or periphery of the chamber 50, in other instances the sealing could be on the outer diameter or periphery of the valve skirt 49). This defines a second pressure surface 10. The valve member 7 has a sealing surface 25, when in the closed position, which seals against the valve body 4 at a second sealing diameter or periphery D2 as shown in FIG. 10. This area within the perimeter of the sealing diameter (if circular) or periphery defines a first pressure surface 8. The first sealing diameter (or periphery) or second pressure surface 10 is greater than the second sealing diameter (or periphery) or first pressure surface 8 and the net difference defines a first pressure area 22. The first pressure area 22 on receipt of fluid into the inner chamber under pressure provides a bias, preferably in addition to the first bias 13, toward the closed position. When the valve member 7 is in the open position an opening is defined between the valve body 4 and valve member 7 to allow fluid flow between the first port, via the opening to the second port as shown for example in FIG. 15 with the fluid 51 escaping via the opening 27. The central or sending spindle 15 is in sliding and sealing engagement with the valve bonnet 39 or part thereof at a third sealing diameter or periphery (D3) which is less than the second sealing diameter or periphery D2. The third sealing diameter or periphery (D3) defines a second pressure area 23, the second pressure area 2 on receipt of fluid 51 under pressure providing a bias toward the open position. Therefore, the valve 1 in use, has the inlet fluid 51 acting on the second pressure surface 23 acting against a second bias 17. When the inlet pressure exceeds the set pressure, the sensing spindle 15 is moved to, or toward, a second spindle position and acts against, that is it is subtractive to the first biasing force 47 and breaks the seal at the first sealing diameter or periphery 25, and the inlet fluid can exit to the outlet.

The method by which the pressure relief valve operates will now be described with reference to FIGS. 13 through 15.

The first pressure area 22 receives fluid under pressure from at least the inlet 2, or a net higher pressure when the inlet 2 is compared to the outlet 3. The net higher inlet pressure and outlet pressure acts, as described on the first pressure area 22 to increase the sealing or net closing force 47 of the valve member 7 against the inlet sealing surface 25. Therefore, as net pressure difference (between inlet and outlet) increases so to will the force sealing the valve member 7 against inlet sealing surface 25 shut while the inlet pressure is below the set pressure. The position of the valve 1 when the pressure difference between inlet and outlet in below the set pressure shown in FIG. 13.

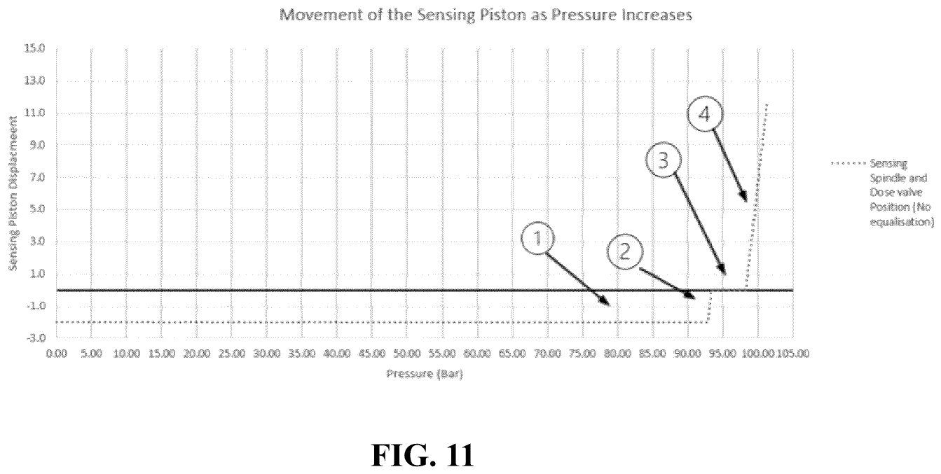

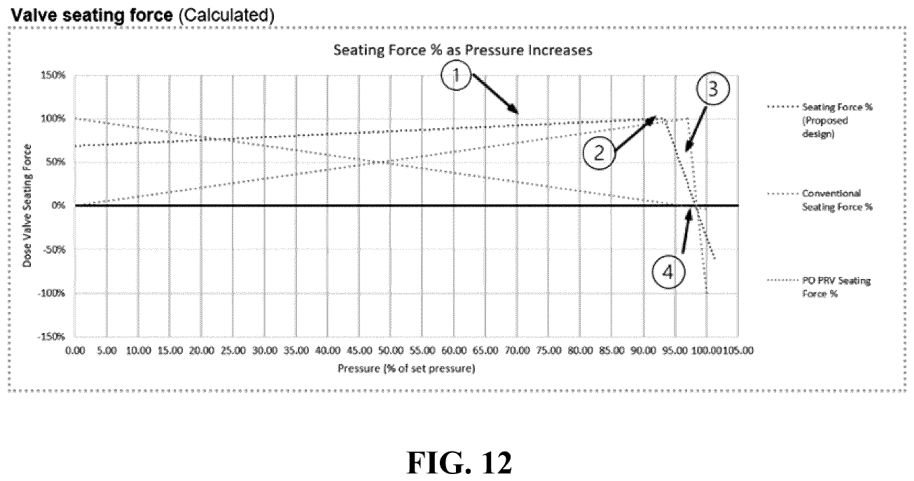

The initial sealing force of the valve member (referred to as the Dose Valve in the graphs of FIGS. 11 and 12) as a percentage of Maximum Sealing Force (that is reached just as set pressure is reached) is shown in the graph of FIG. 12 as the uppermost blue line (1). The start point (y intercept) and gradient (1) of the line can be varied as needed by the strength of the first bias 13 and the first pressure area 22.

The set pressure, which is the pressure the valve will release or open at and allow release of pressure from the inlet to the outlet, is determined by the second pressure area 23 of the sensing spindle 15 and the second bias 17. Increasing the force provided by the second bias 17 (eg by switching to a higher spring constant spring, or winding more force on using the adjuster 42), or decreasing the second pressure area 23 will increase the set pressure.

As the inlet pressure increases the force 47 sealing the valve 7 increases, and the force acting against the sensing spindle 15 increases also as Force equal to pressure multiplied by area. The movement of the sensing spindle 15 (referred to in FIG. 11 as the Sensing Piston) is shown in FIG. 11 as the pressure (bar) increases. In the region (1) before the set pressure (98 bar here) the sensing spindle is not moving and is in the position shown in FIG. 13. At or near the set pressure (about 98 bar in the graph as shown) (2) the sensing spindle moves from its first spindle position 18, passes through a mid position (3) (shown in FIG. 14) and then onwards (4) to its second spindle position 20 (shown in FIG. 15).

This movement of the sensing spindle 15 initially from its first spindle position 18 to a mid position is shown in FIG. 14—it can be seen the stop portion 34 has lifted clear of the stop 29 and the sensing spindle 15 has moved up to contact the valve member 7. This is seen in FIG. 11 where the position of the valve member 7 moves to the solid black line representing zero point (−0.2 indicating the first spindle position 18. 0.0 the mid position as the sensing spindle 15 contacts the valve member 7).

As inlet pressure continues to rise the force the sensing spindle 15 applies to the valve member 7 increases. However, the sending spindle cannot move any further until it overcomes the first bias 13 acting against the valve member 7. Hence the graph in FIG. 11 shows the sensing spindle not moving at point (3) even though inlet pressure continues to rise.

The pressure acting on the sending spindle 15 then reaches the set pressure (about 98 bar) which can overcome the combined applied forces of the first bias 13 and second bias 17. At this point the sensing spindle 17 and the valve member 7 can move as one toward their respective spindle second position 20 and valve second position 24, as shown in FIG. 14 and the valve 1 is unseated, (travelling along graph portion (4) in FIGS. 12 and 11) open and pressure is relieved from the inlet 2 to the outlet 3.

When the inlet pressure drops below the set pressure the movements are reversed and the valve 1 closes.

In the variation shown in FIG. 18 the inlet 2 comes in from the side, and the outlet 3 is at the bottom. Inlet fluid pressure is prevented from moving through the valve to the outlet 3 by annular valve member 7 which has a first sealing surface 12, that forms a seal 21 on an inlet sealing surface 25 which is part of a central, non-moving valve mandrel 46. The seal may be formed by a soft seal, hard seal or combination. In the example shown there is a soft inlet seal 25, and the first sealing surface 12 of the valve member is a hard one. The soft inlet seal 25 is energised to seal by the inlet pressure, and its sealing pressure increases proportionally with the inlet pressure.

A first pressure area 22 on the valve 7 is again acted on by the net pressure difference of the inlet fluid and outlet fluid to drive the valve 7 to a sealing position in the first valve position 14, and the sealing force 47 again increases with increasing inlet pressure difference to outlet pressure. The valve member 7 is connected by at least one radial vane (not visible) to a central valve spindle 45. The valve spindle 45 is in turn biased to seal at the first valve position 14 as shown in FIG. 18 by first bias 13. The valve member 7 has external diameter or periphery seals 36 that are slidingly sealed to the interior diameter or periphery of the valve body 4. If necessary an actuator can act on the valve spindle 45 to open the valve manually.

An annular chamber 100 between the sensing spindle 15 and the valve body has a net differing pressure area between its upper seal and the lower seal. The sensing spindle 15 in is sliding engagement with the valve body and can carry the valve spindle 45 and valve 7. The annular chamber 100 receives the increasing inlet pressure through fluid channels 30 which inlet pressure acts on the net differing pressure area in the annular chamber 100 to act against the second bias 17. At the set pressure the inlet fluid in the annular chamber 100 will overcome the second bias 17 and the sensing spindle will move from the first spindle position 18 as shown, in a direction toward the outlet 3, to a second spindle position (not shown). In moving from the first spindle position 18 the valve member 7 is contacted and opened and fluid in the inlet 2 can then flow to the outlet 3 to relieve pressure.

As pressure rises the following happen:

### Low Pressure Below Set Pressure

Sensing spindle 15 is not in contact with valve member 7, first bias 13 and inlet pressure hold the valve member 7 closed. The second bias 17 holds the sensing piston against it's hard stop.

### Medium Pressure, Not Close to Set Point

No change—pressure still not high enough to make anything move, the valve member 7 is however held harder into it's seat by action of the first pressure area forming and increasing closing force 47.

### Almost at Set Pressure

Sensing spindle 15 (independently) moves towards and contacts the (static) valve member 7, but the inlet pressure is not enough to overcome the first bias 13 and pressure force 47 on the valve member 7.

### Set Pressure Reached

The sensing spindle pressure area (the 2nd pressure area) being greater than the valve member pressure area (first pressure area) and high enough to overcome both the first 13 and second 17 biases (Springs), the sensing spindle 15 contacts and lifts the valve member 7 and opens the valve 1.

The invention therefore has the pressure sensing job done by a sensing spindle 15 which is a separately movable element from the element (valve member 7) which position defines whether the valve is open or closed. The sensing piston (Sensing Stem/spindle 15) moves independently of the flow control element (valve 7)

The sensing piston 7 diameter or periphery (second pressure area 23) is independent of the Piston sealing diameter or periphery (first pressure area 22), meaning a much smaller pressure sensing area can be used to control an equivalent flow area, drastically reducing the spring force (and therefore valve size and material cost) requirement for a given flow capacity requirement.

A substantially cylindrical piston with one cylindrical sealing surface engaged to the valve bonnet, and one annular sealing face which engages with a seat which may be part of the body, or be part of the nozzle assembly.

The sensing stem 15 is assembled through the valve piston 7, through the bonnet. In the ‘closed’ position, the sensing piston is in lowered position and is not in contact or pressing on the valve piston 7, when looking in the orientations in at least FIG. 13. The valve piston 7 is held in closed position by a seating spring 13 and in addition by pressure force generated by the inlet pressure acting on the second pressure area 22 (generated by the difference in diameters or peripheries between pistons cylindrical sealing face and the effective sealing diameter or peripheries between the seat and seal).

When approaching set pressure, the valve piston 7 is forced with high force (due to the high pressure) into the seat by sealing force 47 which is proportional to the inlet pressure)—ensuring a positive seal between the parts and preventing flow/leaking.

Once set pressure is achieved, the sensing stem 15 moves (upwards in FIG. 14 and downwards in FIG. 18) and contacts the valve piston 7, and pushes it upward (FIG. 14) or downward (FIG. 18), compressing the valve pistons seating spring and opening the valve.

By moving the valve piston, the inlet and outlet chambers are linked, opening the valve and ‘relieving’ the inlet to the outlet.

The pistons effective sealing diameters or peripheries (both on the face seal and on the cylindrical sliding seal) are substantially the same, meaning that pressure in the discharge chamber of the valve has little to no effect on the performance and/or behaviour of the valve.

The new pressure relief valve design operates in a similar way to a conventional direct acting valve in that a pressure area is acted upon by incoming pressure against a force reference spring—one key difference is that—that pressure sensing job is done by a sensing spindle 15 which is a separately movable element from the valve element 7 which position defines whether the valve is open or closed (The valve piston).

The sensing piston (Sensing Stem) 15 moves independently of the flow control element 7 (Piston)

The sensing piston diameter or periphery is independent of the Piston sealing diameter or periphery, meaning a much smaller pressure sensing area can be used to control an equivalent flow area, drastically reducing the spring force (and therefore valve size and material cost) requirement for a given flow capacity requirement

The valve Piston's two seals (it's permanent seal [sometimes called it's piston seal] and the face seal) match closely in diameter or periphery-resulting in a small remaining pressure area which acts to hold the valve closed as inlet pressure raises in comparison with outlet pressure

The Piston has its own seating spring/bias which provides the initial seating force to generate the seal between the Piston and the nozzle. As pressure rises, a larger proportion of the valve piston's seating force will be due to pressure force rather than the spring force other bias.

Increasing pressure acts to hold the piston against its seat (the nozzle), until the sensing piston starts to act on the piston to raise it and open the valve.

The layout is very similar geometrically to a conventional valve, therefore the compatibility and interchangeability with popular conventional pressure relief valves is high. Conversion of a conventional pressure relief valve to one using this invention is feasible.

The concept design of a pressure sensing overpressure relief valve is described in it's closed state and it's open state. Key aspects of the design to note are:
The ‘dose valve’ element is balanced with respect to both inlet and discharge pressure
The sensing pathway is fully contained within the valve, with no external sensing hardware required (such as pilot valves of the prior art)
The valve architecture suits in-line servicing, with the trim assembled into one side of the valve
The valve body would be easily adapted to a solenoid actuator or any other type of actuator without significantly updating the trim, and using a simple adapter to switch between actuation methods

A new style of pressure relief valve which is similar in size to existing types of valves, but brings benefits over both:

### Compared to Conventional PRVs

Seat tightness and simmer performance gains over conventional pressure relief valves, without the added cost and complexity of PO PRVs (Pilot Operated Pressure Relief Valves)
Discharge pressure balanced without the use of a fragile and expensive multi-ply metallic bellows
Cost benefits over large and high pressure conventional PRVs due to smaller forces and spring requirements
Reduces seating forces significantly—reducing the load on soft seats and preventing set pressure variation

### Pilot Operated PRVs

Achieves similar performance within a much more ‘familiar’ and simple system—much more like a Conventional PRV
Significant cost benefits over all but the largest PO PRVs
Due to the lack of sensing tubes, the valve has the ability to be used with viscous or dirty fluids, or in applications requiring CIP, opening up a much wider set of use cases

The present invention has the advantages of being Intrinsically well balanced, reducing actuator force needs substantially, the reference force spring or actuator does not act on sealing elements until the valve is actuated, meaning the sealing elements are isolated from high seating loads when not needed, and fully balanced valves are able to be achieved simply and cheaply by adding or removing specific seals from the dose valve itself, without need for extra components.

Valves in keeping with the present invention are much smaller, have lower cost, lower force, and therefore safer springs can be use. Flow capacity (seat diameter or periphery), pressure, and the spring force are no longer related in the same way—resulting in the ability to drastically reduce the spring force required while retaining the same flow capacity

The invention includes seals for achieving the same balancing performance as other types of balanced direct acting valves, however a hermetically sealed bellows stem seal (shown in FIG. 17) can be much smaller diameter or periphery and therefore cheaper than the equivalent conventional bellows seal—and the use of a sliding piston seal does not represent a fugitive emissions risk. Rolling diaphragm piston seals are also and attractive sealing option in this layout due to their very low friction.

Minimum seating force is defined by the seating spring 13 preload, (this also stops the valve elements from rattling/moving and getting damaged when in shipment or handling). As inlet pressure rises, the piston is pressed with increasing force 47 into its seat, therefore retaining high seal integrity. Only when the sensing stem 15 has been displaced by the inlet pressure against its force reference spring 17 to the extent that the sensing piston comes in contact with the valve piston does the force balance on the piston switch—opening the valve.

No additional tubing, valves, assembly required—the valve of the present invention can simply be located in place of the pre-existing valve, and the set pressure adjusted (if not already).

The foregoing description of the invention includes preferred forms thereof. Modifications may be made thereto without departing from the scope of the invention.

1.-83. (canceled)

84. A pressure relief valve to operate on an inlet fluid under pressure to prevent, and allow, the inlet fluid to flow from an inlet to an outlet, comprising or including,
a. A valve body having the inlet leading to an interior of the valve body, and the outlet exiting from the interior,
b. A valve member operatively located within the valve body, having a first pressure area on which the inlet and outlet pressures act, a first sealing surface on a first side thereof to seal against an inlet sealing surface and seal off the inlet from the outlet,
c. a first biasing force urging the valve member to a first valve position whereby it is able to seal the inlet from the outlet,
d. A sensing spindle in fluid communication with the inlet, having a second pressure area in fluid communication with the inlet fluid, a second biasing force to urge the sensing spindle to a first spindle position against the inlet fluid pressure acting on the second pressure area, the second biasing force not additive to the first biasing force,
e. Such that in use, the differential pressure between the inlet and outlet fluid acting on the first pressure area is additive to the first biasing force to seal off the inlet from the outlet, and
f. Wherein in use when the inlet pressure exceeds a set pressure, the sensing spindle via action of inlet pressure on the second pressure area, is moved to, or toward, a second spindle position thereby acting on the valve member to create separation between first sealing surface and the inlet sealing surface and enable fluid flow between the inlet and outlet.

85. A pressure relief valve as claimed in claim 84 wherein there is a first pressure surface on a first side of the valve member in fluid communication with the inlet fluid, and a second pressure surface on a second side of the valve member, opposing the first pressure surface, also in fluid communication with the inlet fluid, the net difference in the first and second pressure surfaces defining the first pressure area on which the inlet and outlet pressures act.

86. A pressure relief valve as claimed in claim 84 wherein the differential pressure between the inlet and outlet fluid acting on the first pressure area produces a net pressure force in addition to the first biasing force that acts to seal the valve member.

87. A pressure relief valve as claimed in claim 84 wherein the separation of the first sealing surface and the inlet sealing surface, reduces a net force the first pressure area provides, such that the first sealing surface and the inlet sealing surface are further separated by the sensing spindle to enable flow between the inlet and outlet.

88. A pressure relief valve as claimed in claim 84 wherein the first and or second bias is adjustable.

89. A pressure relief valve as claimed in claim 84 wherein the first bias is a spring or other elastic or similar bias that can provide initial force to hold the first sealing surface against the inlet sealing surface.

90. A pressure relief valve as claimed in claim 84 wherein the area of the second pressure surface is greater than the area of the first pressure surface to increase the force holding the valve member sealed.

91. A pressure relief valve as claimed in claim 84 wherein the ratio of the area of the first pressure surface to the second pressure surface can be adjusted through the inlet to vary the energising force closing the valve member.

92. A pressure relief valve as claimed in claim 84 wherein there is an annular chamber about the valve member in fluid communication with the outlet.

93. A pressure relief valve as claimed in claim 84 wherein the second pressure area, or pressure surface of the spindle is used to overcome the combined closing force of the first bias and the resultant force of the first pressure area and the inlet and outlet pressures acting on it to move the valve member from the first valve position and unseal the valve member.

94. A pressure relief valve as claimed in claim 84 wherein there is at least one fluid channel between the first pressure surface and the second pressure surface

95. A pressure relief valve as claimed in claim 84 wherein the fluid channel is within a periphery of the first sealing surface, such that when the first sealing surface is sealed to the inlet sealing surface there is no fluid communication to the outlet.

96. A pressure relief valve as claimed in claim 84 wherein the first biasing force is provided by a coil spring located about an external surface of the valve member, and wherein the second biasing force is provided by a coil spring.

97. A pressure relief valve as claimed in claim 84 wherein there is a stop to hold the sensing spindle in the first spindle position against the second biasing force.

98. A pressure relief valve as claimed in claim 84 wherein the second bias is adjustable in its force to allow, in part, adjustment of the set pressure.

99. A pressure relief valve as claimed in claim 84 wherein the at least one fluid channel is at an axial centre of the valve member and the sensing spindle passes therethrough toward the inlet, wherein the sensing spindle and valve member translate from their first respective positions to their second respective positions along a longitudinal axis, and wherein the annular member defining the valve member, first sealing surface, and inlet sealing surface are concentric with the longitudinal axis.

100. A method of operating a pressure relief valve to operate on an inlet fluid under pressure to prevent, and allow, the inlet fluid to flow from an inlet to an outlet, comprising or including,
a. Biasing a valve member to seal an opening from the inlet to the outlet, the valve member having a first pressure area which the inlet fluid pressure can act on to increase the sealing force of the valve member onto a seat in addition to the valve member bias to seal the inlet from the outlet,
b. Biasing a sensing spindle against inlet fluid pressure from the inlet acting on a second pressure area of the sensing spindle, the sensing spindle bias not adding to the valve member bias, the sensing spindle bias providing a set pressure under which the sensing spindle does not move, wherein,
c. Below the set pressure the sensing spindle is not in contact with valve member, the valve member bias and inlet pressure on the first pressure area hold the valve element sealed, and the sensing spindle bias holds the sensing spindle against a hard stop,
d. Once the set pressure is reached the inlet fluid pressure on the second pressure area, being greater than the first pressure area, is now high enough to overcome both the valve member bias and sensing spindle bias, the sensing spindle then moves the valve member to unseal the opening, and allow fluid flow between the inlet and outlet,
e. such that a pressure relief valve is provided that has low initial sealing pressure and which sealing pressure increases with inlet fluid pressure preventing inlet fluid flow to the outlet, until the set pressure is reached at which point the opening is unsealed to allow fluid flow from the inlet to the outlet.

101. A method as claimed in claim 100 wherein just below the set pressure the sensing spindle, independent of the valve member, moves towards and contacts the presently static valve member, but the inlet pressure is not enough to overcome the valve member bias and first pressure area force on the valve member.

102. A method as claimed in claim 100 wherein there is a first pressure surface on a first side of the valve member in fluid communication with the inlet fluid, and a second pressure surface on a second side of the valve member, opposing the first pressure surface, also in fluid communication with the inlet fluid, the net difference in the first and second pressure surfaces defines the first pressure area on which the inlet and outlet pressures act, wherein the differential pressure between the inlet and outlet fluid acting on the first pressure area produces a net pressure force in addition to the first biasing force that acts to seal the valve member, and wherein there is a third pressure surface on the sensing spindle which defines the second pressure area.

103. A method as claimed in claim 100 wherein the first and or second bias is adjustable.

104. A method as claimed in claim 100 wherein the first bias is a spring or other elastic or similar bias that can provide initial force to hold the first sealing surface against the inlet sealing surface.

105. A method as claimed in claim 100 wherein the area of the second pressure surface is greater than the area of the first pressure surface to increase the force holding the valve member sealed.

106. A method as claimed in claim 100 wherein the ratio of the area of the first pressure surface to the second pressure surface can be adjusted through the inlet to vary the energising force closing the valve member.

107. A method as claimed in claim 100 wherein the second pressure area, or pressure surface of the spindle is used to overcome the combined closing force of the first bias and the resultant force of the first pressure area and the inlet and outlet pressures acting on it to move the valve member from the first valve position and unseal the valve member.

108. A method as claimed in claim 100 wherein the sensing spindle and valve member translate from their first respective positions to their second respective positions along a longitudinal axis, and wherein the annular member defining the valve member, first sealing surface, and inlet sealing surface are concentric with the longitudinal axis.

109. A method as claimed in claim 100 wherein the fluid channels are unsaled in a first movement of the valve member toward the second valve position, and the valve skirt, or a second fluid channel thereof, is unsealed in a second further movement of the valve member towards the second valve position.

110. A method as claimed in claim 100 wherein the valve member is balanced with respect to both inlet and outlet pressures.
